(19) United States
(12) Patent Application Publication
(10) Pub. No.: US 2009/0013003 A1
(43) Pub. Date: Jan. 8, 2009

(54) CONNECTION METHOD AND CONNECTION SYSTEM FOR INTERNET ACCESS BY COMMUNICATION DEVICE

(75) Inventors: Chiung-Wen Chang, Taipei (TW); Wen-Shiu Hsu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/166,294

(22) Filed: Jul. 1, 2008

(30) Foreign Application Priority Data
Jul. 4, 2007 (TW) 96124333

(51) Int. Cl. G06F 15/16; G06F 15/173; G06F 17/30

(52) U.S. Cl. 707/104.1; 709/227; 709/220; 707/E17.032

(57) ABSTRACT

A connection method for Internet access by a communication device is provided, and the connection method includes the step of searching for a communication device with a mobile Internet access function and connecting the selected communication device. The present invention includes the step of setting dial-up network of the connected communication device, establishing a dial-up network connection via the set communication device, and finally connecting to the Internet through the mobile network connection service of the communication device.

### CROSS-REFERENCE TO RELATED APPLICATION

This application claims the priority benefit of Taiwan application serial no. 96124333, filed on Jul. 4, 2007. The entirety of the above-mentioned patent application is hereby incorporated by reference herein and made a part of this specification.

### BACKGROUND OF THE INVENTION

1. Field of the Invention

The invention relates to a method for network connection and, more particularly, to a connection method for Internet access by a communication device.

2. Description of the Related Art

In the modern information society, people much rely on electronic products. The electronic products such as computers and mobile phones can be seen everywhere. In the modern life, persons often take a remote communication via the phones. Along with the decrease of the price of the mobile phones and the cost of telecommunications service, the mobile phones are regarded as one of the most convenient and rapidest communication tools.

To meet the requirement of users for mobile data transmission, telecommunications service of a conventional global system for mobile communications (GSM) standard is inadequate, and telecommunications service of a new third generation communication network (3G for short) standard gradually becomes popular. The wireless data transmission rate of the 3G standard is much greater than that of the GSM standard, and then the telecommunications service of 3G can provide a real-time image transmission function besides a common audio transmission function. The telecommunications service of the 3 G standard is extended, and then a common computer device can realize the mobile Internet access via a mobile phone with the 3G standard as a modem. Then, a user can realize a dial-up Internet access via the 3G mobile phone without network service. Besides the mobile phone, the user also may use other devices to realize a dial-up Internet access. For example, a device having a universal serial bus (USB) or a memory card (such as a memory card modem supporting a 3G connection function) is used to realize 3G dial-up Internet access.

In the conventional technology, when the user utilizes the 3G mobile phone to realize the dial-up Internet access, he needs to install corresponding software (which is possible to include a driving program therein) in the computer device according to the brand of the mobile phone first. That is, when a computer device in which only the software of the A brand of a 3G mobile phone is installed, it cannot realize the dial-up Internet access via the B brand of a 3 G mobile phone, which causes the inconvenience in use.

### BRIEF SUMMARY OF THE INVENTION

The invention provides a connection method and a connection system for Internet access by a communication device, and then a computer device can realize dial-up Internet access by different communication devices. Thus, software corresponding to different brands of the communication devices does not need to be installed in the computer device.

The invention provides a connection method for Internet access by a communication device, and the connection method includes the step of searching for a communication device with a mobile Internet access function. When a plurality of communication devices for network connection are searched out, the communication devices are displayed in a list for a user to select. The selected communication device is connected according to the selection of the user, and dial-up network of the communication device which can be connected are set. In this way, the user can establish a dial-up network connection via the set communication device to connect to the Internet via a mobile network connection service on the communication device.

In one embodiment of the invention, the mobile network connection service may be a third generation communication network.

In one embodiment of the invention, the step of searching for a communication device includes the step of detecting whether a communication device for network connection exists when a network connection request is received, and in the step, communication devices having a wired interface or a wireless interface all are searched for at the same time. When no communication device for network connection is found, a message showing that no communication device can be used for network connection is sent out. When a communication device for network connection is found, whether a plurality of communication devices for network connection exist is detected. If only one communication device for network connection is detected, the communication device is automatically connected. On the contrary, if a plurality of communication devices for network connection are found, the communication devices are displayed in a list for a user to select, and one of the communication devices is connected according to the selection of the user.

In the step of connecting the communication device of the invention, when a device connection request is received, whether the communication device which needs to be connected utilizes a wireless mode or a wired mode is checked. When the communication device which needs to be connected utilizes the wireless mode, whether the communication device can be wirelessly connected is checked. If the communication device which needs to be connected utilizes a wired mode, whether the connection port of the communication device can normally operate is checked.

In the step of setting the communication device which needs to be connected of the invention, connection parameters of the communication device which needs to be connected are set, and corresponding additional initialization instruction is set according to the Internet service provider which needs to be connected. In this way, the invention can utilize the set communication device to set a dial-up network to establish a network connection.

The invention provides a connection system for Internet access by a communication device, and the connection system at least includes a search unit, a connection unit, a setting unit and a dial-up unit. When a user starts the function of accessing the Internet by a communication device, the search unit can search whether a communication device with a mobile Internet access function exists. When a plurality of communication devices for network connection are searched out by the search unit, the communication devices are displayed in a list for a user to select. The connection unit can connect the communication device which needs to be connected according to the selection of the user and generate a test result for the setting unit. The setting unit can set dial-up network of the communication device which needs to be connected to set up a dial-up connection and generate corresponding setting values. The dial-up unit may be coupled to the setting unit to realize dial-up Internet access via the communication device according to the dial-up connection.

The wired connection mode of the invention may utilize a universal serial bus (USB) interface, and the wireless connection mode of the invention may utilize a Bluetooth transmission interface.

The invention utilizes a communication device to realize common dial-up Internet access, and therefore, additional software does not need to be installed. The invention can set parameters in accordance with communication devices and Internet service providers, and therefore, the invention can effectively perform a connection program of dial-up Internet access via a communication device.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a functional block diagram showing a connection system according to a preferred embodiment of the invention.

FIG. 2 is a flow chart showing a connection method for Internet access by a communication device according to a preferred embodiment of the invention.

FIG. 3 is a flow chart showing a method for searching for a communication device with an Internet access function according to a preferred embodiment of the invention.

FIG. 4 is a flow chart showing a method for connecting a communication device according to a preferred embodiment of the invention.

FIG. 5 is a flow chart showing a method for setting a communication device according to a preferred embodiment of the invention.

### DETAILED DESCRIPTION OF THE EMBODIMENTS

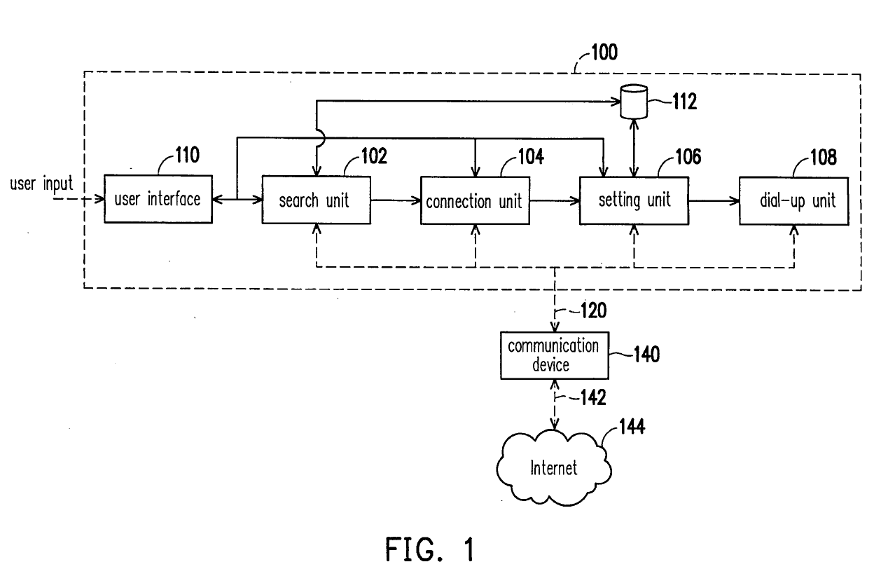

FIG. 1 is a functional block diagram showing a connection system according to a preferred embodiment of the invention. As shown in FIG. 1, a connection system 100 provided by the embodiment of the invention and a computer (not shown) are located at the same side, and the connection system 100 allows the computer device to be connected to the Internet 144 via a communication device 140 and a connection service 142 such as a third generation communication network. In the embodiment, the computer device may be a desktop personal computer or a portable computer. The communication device 140 may be, for example, a mobile phone with a mobile Internet access function or a modem or a network card having a related function. A connection interface of the communication device 140 may be a wireless (such as Bluetooth transmission) or wired (such as a universal serial bus) interface.

The connection system 100 of the embodiment is connected to the communication device 140 via a connection interface 120 on the computer device. Generally speaking, the connection interface 120 may be a wireless connection interface or a wired connection interface. The wireless connection interface includes a Bluetooth transmission interface, a wireless network interface and so on, and the wired connection interface may be a universal serial bus (USB) interface or a memory card interface.

As shown in FIG. 1, the connection system 100 at least includes a search unit 102, a connection unit 104, a setting unit 106 and a dial-up unit 108. In the embodiment, the search unit 102 is coupled to a user interface 110, the connection unit 104, the setting unit 106, the dial-up unit 108, a database 112 and the communication device 140, respectively. The connection unit 104 is coupled to the setting unit 106, and the setting unit 106 is coupled to the dial-up unit 108. In some embodiments, the connection system 100 may include the user interface 110, and the user interface 110 may be coupled to the search unit 102, the connection unit 104 and the setting unit 106, respectively. In other embodiments, the setting unit 106 may be coupled to the database 112.

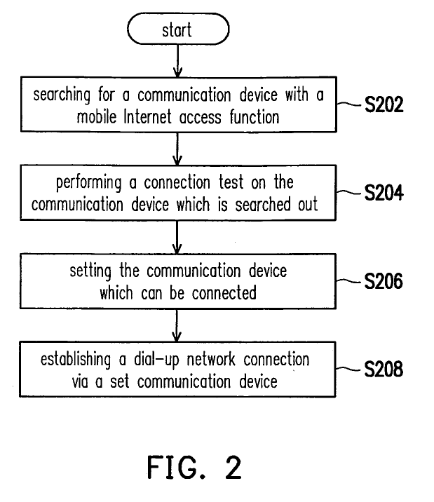

FIG. 2 is a flow chart showing a connection method for Internet access by a communication device according to a preferred embodiment of the invention. As shown in FIG. 1 and FIG. 2, when a user starts a function of accessing the Internet by a communication device via the user interface 110, the user interface 110 can generate a network connection request, and the network connection request is transmitted to the search unit 102 to allow the search unit 102 to search for a communication device with a mobile Internet access function as shown in the step S202.

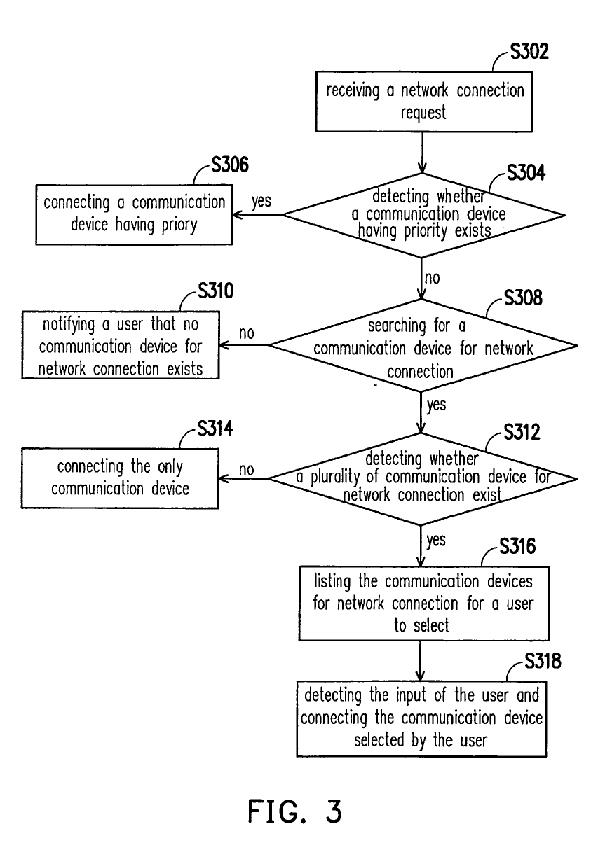

FIG. 3 is a flow chart showing the detailed steps of the step S202 in FIG. 2. As shown in FIG. 1 and FIG. 3, when the user interface 110 sends out a network connection request, the search unit 102 receives the network connection request as shown in the step S302. Afterwards, the search unit 102 performs the step S304. That is, the search unit 102 detects whether a communication device having priority is connected to the computer device. When the search unit 102 finds that the communication device having priority is connected to the computer device (“yes” in the step S304), the communication device having priority is directly connected as shown in the step S306.

If the search unit 102 finds that no communication device having priority is connected to the computer device (“no” in the step S304), the step S308 is performed. That is, a communication device for network connection is searched for. For example, the search unit 102 can check whether a dial-up networking (DUN) profile of a device exists or perform an AT command to check whether a communication device is connected to the computer device in a Bluetooth transmission mode or a wired transmission mode.

If the search unit 102 finds that no communication device with a mobile Internet access function is connected to the computer device via the connection interface 120 (“no” in the step S308), a message showing that no communication device for network connection exists is sent out via the user interface 110 to notify the user in the step S310.

If the search unit 102 searches out at least a communication device connected to the computer device via the connection interface 120 (“yes” in the step S308), the search unit 102 detects whether a plurality of communication devices for network connection exist in the step S312. If one communication device is connected to the computer device via the connection interface 120 (“no” in the step S312) only, a device connection request is generated and sent to the connection unit 104 to automatically connect the only communication device in the step S314.

If the search unit 102 searches out more than one communication device connected to the computer device (“yes” in the step S312), the step S316 is performed. That is, the communication devices for network connection are listed and displayed via the user interface 110 for a user to select. In the embodiment, the communication device can be listed in sequence according to, but not limited to, priority, the number of times of successful connection and so on. When the user selects one of the communication devices (such as 140) via the user interface 110 for network connection, the search unit 102 detects the input of the user via the user interface 110 to send out a device connection request to the connection unit 104 in the step S318.

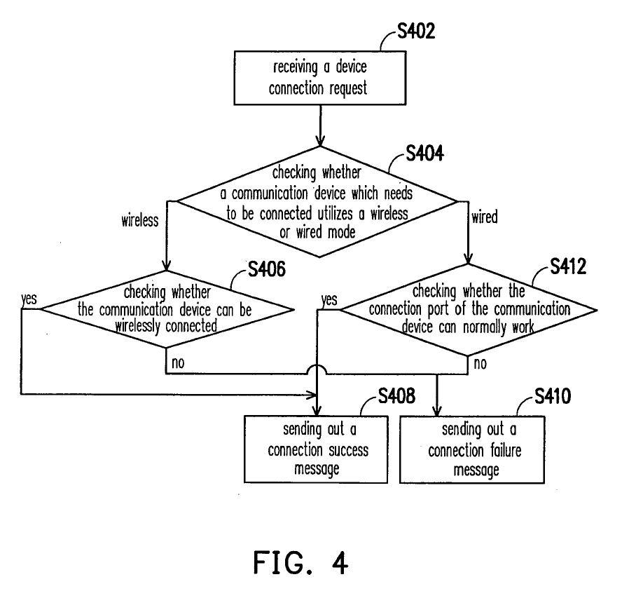

As shown in FIG. 2 and FIG. 4, after the step S202 is performed, the connection unit 104 allows the communication device 140 which is searched out to be connected in the step S204. FIG. 4 is a flow chart showing the detailed steps of the step S204 in FIG. 2. As shown in FIG. 4, when the search unit 102 sends out a device connection request as shown in FIG. 3, the connection unit 104 can receive the device connection request as shown in the step S402 and check whether the communication device 140 which needs to be connected is connected to the computer device in a wireless or wired mode as shown in the step S404.

When the connection interface 120 utilizes the wireless mode (“wireless” in the step S404), the step S406 is performed. That is, whether the communication device 140 can wirelessly communicate is tested. If the wireless connection is a Bluetooth transmission connection, the connection unit 104 confirms whether the communication device 140 can perform a Bluetooth pairing. If the connection unit 104 confirms that the communication device 140 can be wirelessly connected (for example, the communication device 140 is successfully paired by Bluetooth), the step S408 is performed. That is, a connection success message is sent out via the user interface 110. On the contrary, if the connection unit 104 finds that the communication device 140 cannot be wirelessly connected (for example, the communication device 140 refuses to pair or closes its Bluetooth function), the step S410 is performed. That is, a connection failure message is sent out to notify the user via the user interface 110.

If the connection interface 120 utilizes a wired mode, the connection unit 104 tests whether a connection port of the communication device 140 can normally operate as shown in the step S412. If the connection unit 104 confirms that the connection port of the communication device 140 can normally operate (“yes” in the step S412), the step S408 is performed. On the contrary, if the connection unit 104 finds that the connection port of the communication device 140 cannot normally operate (“no” in the step S412), the step S410 is performed.

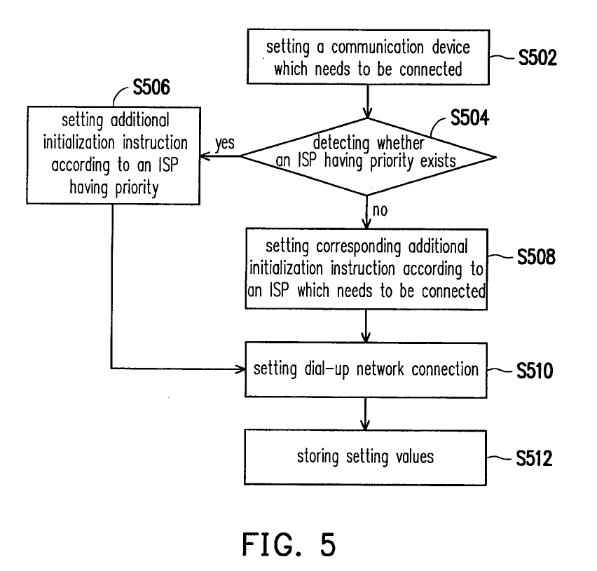

As shown in FIG. 1 and FIG. 2, when the communication device 140 is connected, the step S206 is performed. That is, the setting unit 106 performs the setting steps. FIG. 5 is a flow chart showing the detailed steps of the step S206 in FIG. 2. As shown in FIG. 5, after the connection unit 104 allows the communication device 140 to be connected, the setting unit 106 can obtain corresponding parameter values from the database according to the type of the communication device 140 to set dial-up network of the communication device as shown in the step S502, and the setting unit 106 checks whether the database has the setting of an Internet service provider (ISP) having priority as shown in the step S504. If the setting unit 106 finds the setting of the Internet service provider (ISP) having priority in the database (“yes” in the step S504), the step S506 is performed. That is, additional initialization instruction is set according to the ISP having priority, and the step S510 is performed, that is, the dial-up network connection is set.

When the setting unit 106 does not find the setting of any ISP having priority (“no” in the step S504), corresponding additional initialization instruction is set according to the ISP that the communication device is connected to as shown in the step S508.

For example, if the service interface 142 is a third generation communication network, the setting unit 106 can select a corresponding initialization string to set according to a look-up table stored in the database 112. The initialization string may be as follows:
AT+CGDCONT=1, “ip”, “internet”

In some embodiments, if the setting unit 106 does not find corresponding initialization instruction in the database 112, it can require the user to input via the user interface 110 and store data input by the user into the database 112 to facilitate the next connection of the computer device.

After the step S508 is performed, the setting unit 106 can set a dial-up network connection via the communication device 140 and generate corresponding setting values as shown in the step S510. In some embodiments, the setting unit 106 can store the setting values into the database 112 as priority setting to increase the connection speed of the computer device via the communication device 140 next time, as shown in the step S512.

Assuming that the connection interface 120 is a Bluetooth transmission interface, after the setting unit 106 sets the dial-up network, the communication device 140 has corresponding address information at the Bluetooth interface. The setting unit 106 can store the address information into the database 112 at that moment. When the computer device needs to access the Internet via the communication device 140 next time, the search unit 102 can directly obtain the address information having high priority from the database 112, and then whether the communication device 140 exists is checked via the address information before a complete search. The setting unit 106 can directly obtain corresponding setting values from the database 112 to set the communication device 140.

As shown in FIG. 2, after the setting unit 106 performs the step S206, the dial-up unit 108 is notified. In this way, the dial-up unit 108 performs the dial-up Internet access via the communication device 140 and the service interface 142 according to the dial-up network set by the setting unit 106, and then a data package transmission path is built between the computer device and the Internet 144.

To sum up, since the invention utilizes a communication device to perform common dial-up Internet access, additional software does not need to be installed. In the invention, different setting may be done according to the type of communication devices and ISPs, and therefore, the connection efficiency increases. The invention allows the user to set parameters himself, and data set by the user can be stored. Thus, the invention is further flexible in use.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A connection method for Internet access by a communication device, which is applied to a computer device, the connection method comprising the steps of:
searching for a communication device with a mobile Internet access function;
when a plurality of communication devices for network connection are searched out, displaying the communication devices in a list for a user to select;
connecting one of the communication devices according to the selection of the user;
setting the communication device which can be connected; and
establishing a dial-up network connection via the set communication device to connect to the Internet via a connection service.

2. The connection method according to claim 1, wherein the step of searching comprises the steps of:
receiving a network connection request;
detecting whether a communication device for network connection exists;
sending out a message showing that no communication device for network connection exists when no communication device for network connection is detected; and
detecting whether a plurality of communication devices for network connection exist when one communication device for network connection is detected.

3. The connection method according to claim 2, wherein the step of searching further comprises the steps of:
detecting whether a communication device having priority exists; and
connecting the communication device having priority.

4. The connection method according to claim 2, wherein the step of searching further comprises the step of automatically connecting the communication device when only one communication device for network connection is detected.

5. The connection method according to claim 1, wherein the step of connecting the communication device comprises the steps of:
receiving a device connection request; and
checking whether the communication device which needs to be connected utilizes a wireless interface or a wired interface.

6. The connection method according to claim 5, wherein the step of connecting the communication device further comprises the steps of:
checking whether the communication device can be wirelessly connected when the communication device which needs to be connected utilizes the wireless interface;
sending out a connection success message when the communication device can be wirelessly connected; and
sending out a connection failure message when the communication device cannot be wirelessly connected.

7. The connection method according to claim 5, wherein the step of connecting the communication device further comprises the steps of:
checking whether a connection port of the communication device can normally operate when the communication device which needs to be connected utilizes the wired interface;
sending out a connection success message when the connection port of the communication device can normally operate; and
sending out a connection failure message when the connection port of the communication device cannot normally operate.

8. The connection method according to claim 1, wherein the step of setting comprises the steps of:
setting connection parameters of the communication device which needs to be connected;
setting corresponding additional initialization instruction according to an Internet service provider (ISP) which needs to be connected; and
setting a dial-up network for network connection.

9. The connection method according to claim 8, wherein the step of setting further comprises the steps of:
checking whether the setting of an ISP having priority exists; and
setting additional initialization instruction according to the ISP having priority when the setting of the ISP having priority exists.

10. The connection method according to claim 8, wherein the step of setting further comprises the step of storing the result of setting.

11. The connection method according to claim 1, wherein the connection service comprises a third generation communication network.

12. A connection system for Internet access by a communication device, which is applied to a computer device, the connection system comprising:
a search unit, wherein when a user starts a function of accessing the Internet by a communication device, the search unit is used for searching whether a communication device with a mobile Internet access function exists, and when a plurality of communication devices for network connection are searched out, the communication devices are displayed in a list for a user to select;
a connection unit which is coupled to the search unit and is used for connecting one of the communication devices according to the selection of the user and generating a test result;
a setting unit which is coupled to the connection unit and is used for setting dial-up network for the communication device which can be connected to set up a dial-up connection and generate a plurality of corresponding setting values; and
a dial-up unit which is coupled to the setting unit and is used for dial-up Internet access via the communication device according to the dial-up connection.

13. The connection system according to claim 12 further comprising:
a user interface which is coupled to the search unit and the connection unit and is used for the user to input and displaying the search result and the test result for the user; and
a database which is coupled to the setting unit to allow the setting unit to set the communication device according to the data stored in the database and stores the setting values to increase the Internet access speed of the computer device via the communication device next time.

14. The connection system according to claim 12, wherein the communication device is connected to the computer device via a universal serial bus (USB).

15. The connection system according to claim 12, wherein the communication device is connected to the computer device via Bluetooth transmission.

16. The connection system according to claim 12, wherein the computer device comprises a desktop personal computer or a portable computer.

17. The connection system according to claim 12, wherein the communication device is a mobile phone with a mobile network function.

18. The connection system according to claim 12, wherein the search unit can further check whether a communication device having priority exists, and when the search unit finds that the communication device having priority is connected to the computer device, the communication device having priority is directly connected and is set.
